(19) United States
(12) Patent Application Publication
(10) Pub. No.: US 2008/0078880 A1
(43) Pub. Date: Apr. 3, 2008

(54) Aircraft fuel pipe coupling

(75) Inventor: David Patrick Petit, Bristol (GB)

Correspondence Address: NIXON & VANDERHYE, PC, 901 NORTH GLEBE ROAD, 11TH FLOOR, ARLINGTON, VA, 22203, US

(73) Assignee: AIRBUS UK LIMITED, Bristol (GB)

(21) Appl. No.: 11/890,516

(22) Filed: Aug. 7, 2007

(30) Foreign Application Priority Data
Sep. 29, 2006 (GB) GB0619295.9

(51) Int. Cl. B64D 37/00; F16L 21/00; H01R 4/60

(52) U.S. Cl. 244/135 R; 285/53; 439/192

(57) ABSTRACT

A coupling for connecting fuel pipes in an aircraft is provided. At least one of the fuel pipes is capable of movement with respect to the coupling. The coupling comprises a pipe end fitting and a socket arrangement. The pipe end fitting is located within the socket arrangement. At least one resiliently flexible electrical contact is located between the pipe end fitting and the socket arrangement. The coupling may thus form a flexible coupling electrically connecting two pipes to prevent static electricity build-up whilst permitting movement between the pipes.

### TECHNICAL FIELD

The present invention relates to aircraft fuel pipe couplings and in particular but not exclusively flexible fuel pipe couplings for connecting a fuel pipe in an aircraft fuel system to another fuel pipe.

### BACKGROUND OF THE INVENTION

There is a danger in aircraft fuel systems of a build up of static electricity on one pipe in comparison to another pipe to which it is connected. This may cause an electrical discharge or spark which could result in the fuel carried by the fuel pipes igniting. In the prior art, fuel couplings include a wire bonded to each side of a coupling in order to electrically connect them and prevent static build up on parts of the connector. The wire is bonded to lugs present on the coupling and as a further safety feature there may be one or more back up wires and corresponding lugs. The arrangement of the prior art is both heavy and complex. The position of the connection externally to the coupling also leaves it vulnerable to damage. FIG. 1 shows an embodiment of the prior art, where a fuel pipe coupling 101 comprises a socket arrangement 102, in which a pipe end fitting 103 is located, a seal 104, sealing the contact between the socket arrangement and the pipe end fitting, and a bonding lug 105 welded to the fuel pipe connected to the pipe end fitting 103, a further bonding lug 106 that has been machined on the socket arrangement and a bonding lead 107 between the two lugs 105, 106, electrically connecting one side of the coupling to the other. As can be seen, the lugs 105, 106, are considerable in size and add weight to the fuel pipe coupling and the bonding lead 107 is also vulnerable to damage as it is very exposed.

The present invention seeks to mitigate or overcome one or more of the above-identified disadvantages associated with the prior art coupling.

### SUMMARY OF THE INVENTION

The invention provides a coupling for connecting fuel pipes wherein at least one of the fuel pipes is capable of movement with respect to the coupling, the coupling comprising

a pipe end fitting and a socket arrangement, the pipe end fitting being located within the socket arrangement, and

at least one resiliently flexible electrical contact located between the pipe end fitting and the socket arrangement.

The coupling may be either a flexible coupling or a semi-flexible coupling. In a flexible coupling both of the pipes connected together may move with respect to the coupling. The coupling may permit rotational movement of the pipe with respect to the coupling. Alternatively, or additionally, the coupling may permit pivotal movement of the pipe with respect to the coupling. Alternatively, or additionally, the coupling may permit movement along the longitudinal axis of the coupling. In a semi-flexible coupling just one of the pipes is capable of movement with respect to the coupling, the other pipe being fixed in position.

The location of the resiliently flexible electrical contact between the pipe end fitting and the socket mitigates the problem of possible damage to an electrical connection on the outside of a coupling. The coupling of the present invention may also be lighter than those of the prior art and be easier to assemble. The location of the resiliently flexible electrical contract may be such that its integrity can be checked with a visual inspection.

Preferably, the resiliently flexible electrical contact is fixed to one of either the pipe end fitting or the socket arrangement. Thus, the resiliently flexible electrical contact may be fixed to the pipe end fitting but not fixed to the socket arrangement or alternatively the resiliently flexible electrical contact may be fixed to the socket arrangement but not fixed to the pipe end fitting. Preferably, the resiliently flexible electrical contact is slideably movable with respect to one of the pipe end fitting or the socket arrangement. The resiliently flexible electrical contact may be slideably movable with respect to both the pipe end fitting and the socket arrangement.

The resiliently flexible electrical contact may be an electrically conductive brush. Preferably, there are a plurality of electrically conductive brushes. The or each electrically conductive brush may be metallic. The or each electrically conductive brush may comprise a plurality of metallic bristles.

The resiliently flexible electrical contact may comprise elastomeric material. The resiliently flexible electrical contact may comprise carbon, which may for example be sufficiently conductive to facilitate electrical conductivity of the contact. The resiliently flexible electrical contact may comprise metallic wires, which may be embedded in a carrier material, to facilitate electrical conductivity of the contact. The resiliently flexible electrical contact may be an electrically conductive lip. The electrically conductive lip may be a carbon-loaded elastomeric material. The electrically conductive lip may include embedded metallic wires. The electrically conductive lip may extend substantially all the way around the pipe end fitting and/or the socket arrangement. Alternatively, there may be provided a plurality of electrically conductive lips, which are positioned around the pipe end fitting and/or the socket arrangement. The lips may for example be in the form of, or comprise, one or more flanges which extend around part(s) only of the pipe end fitting and/or the socket arrangement.

The resiliently flexible electrical contact may be mounted on the socket arrangement. The resiliently flexible electrical contact may be mounted on a nut, the nut being attached to the socket arrangement. The nut may be welded to the socket arrangement. The nut may be screwed onto the socket arrangement.

The resiliently flexible electrical contact may be mounted on the pipe end fitting. The resiliently flexible electrical contact may be welded to the pipe end fitting.

The resiliently flexible electrical contact may be removable from the coupling. Advantageously, this would enable it to be replaced by a further resiliently flexible electrical contact should it become worn or damaged.

The coupling may be an aircraft fuel pipe coupling and may for example be located in an aircraft, for example forming a part of the fuel system thereof.

The invention further provides a method of connecting a first aircraft fuel pipe to a second aircraft fuel pipe, wherein the method comprises the steps of:

forming a first pipe end at an end of the first pipe,

attaching a socket to an end of the second pipe, the first pipe end being at least partially accommodated by the socket in sealing engagement, thereby physically joining the first and second pipes in fluid communication,

electrically connecting the first pipe to the second pipe by means of providing a resiliently flexible electrical contact between the first pipe end and the socket, and

causing at least one of the first pipe and the second pipe to move relative to the other of the first pipe and the second pipe.

The first pipe end may be formed by means of attaching a pipe end fitting to the end of the first pipe. The pipe end fitting and the socket may together form at least part of a coupling between the two pipes. The steps of the method do not necessarily need to be performed in the order presented above. The method is preferably performed on an aircraft, for example during and/or after assembly of the aircraft. Aircraft fuel may for example be passed along the pipes.

The invention also provides a kit of parts for electrically connecting aircraft fuel pipes, wherein the kit of parts includes a pipe end fitting and a socket arrangement for forming a fuel pipe coupling and a resiliently flexible electrical contact suitable for arrangement between, and for electrically connecting, the pipe end fitting and the socket arrangement.

The invention further provides an aircraft including a fuel system comprising a plurality of fuel pipes and at least one coupling as has been described above. The invention yet further provides an aircraft fuel system including a plurality of fuel pipes and at least one coupling as has been described above.

It will of course be appreciated that features described in relation to one aspect of the invention may be incorporated into other aspects of the invention. For example, the features of the coupling according to invention may be incorporated into the method of connecting aircraft fuel pipes of the invention. For example, the movement of the pipes effected in the method may include one or more of the relative movements described above as optionally being permitted by means of the coupling. The method may be performed using the coupling of the invention. The coupling of the invention may be adapted for performing the method of the invention.

### BRIEF DESCRIPTION OF THE DRAWINGS

Embodiments of the fuel pipe coupling of the invention will now be described, by way of example only, with reference to the accompanying drawings of which:

FIG. 1 shows a coupling of the prior art;

FIG. 2A shows a first embodiment of the invention;

FIG. 2B shows an end view of part of the first embodiment;

FIG. 3A shows a second embodiment of the invention; and

FIG. 3B shows an end view of part of the second embodiment.

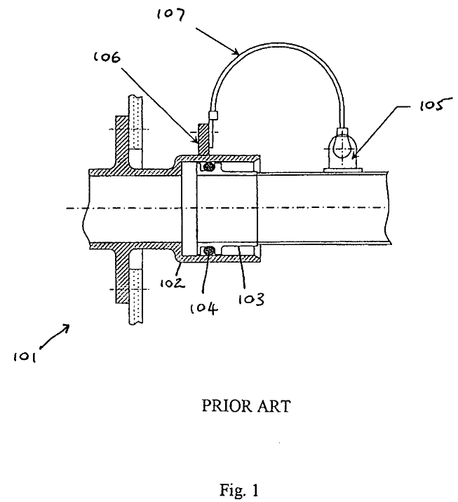

### DETAILED DESCRIPTION OF EMBODIMENTS

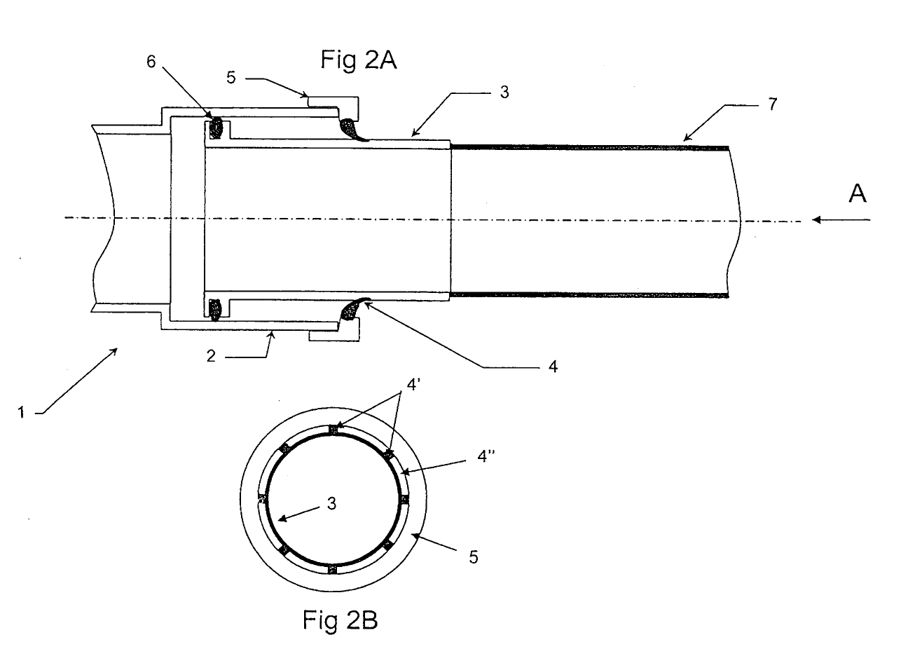

FIG. 2A shows a first embodiment of the invention including a fuel pipe coupling 1 comprising a socket 2, a pipe end fitting 3, a resiliently flexible electrically conductive lip 4, a nut 5, an O-ring seal 6, and a fuel pipe 7. The pipe end fitting 3 is located within the socket 2 and includes the seal 6 between the male outer surface of the pipe end fitting 3 and the female inner surface of the socket 2. The nut 5 is fitted (for example by welding) to the end of the socket 2. The conductive lip 4 is attached to the nut 5 and protrudes from the nut such that it contacts the pipe end fitting 3. The coupling connects fuel pipes of an aircraft fuel system.

FIG. 2B is a view of the connector 1 from the direction of arrow A in FIG. 2A. It shows the pipe end fitting 3, the nut 5 and the conductive lip 4. The conductive lip 4 is made up of a plurality of metallic wires 4′ embedded into a elastomeric material 4″. As is clearly shown, the metallic wires 4′ provide an electrical contact between the nut 5 and the pipe end fitting 3.

In this first embodiment the coupling is a flexible coupling and thus both the socket 2 and the pipe end fitting 3 are free to move. However, for clarity, the movement of the coupling will be described as if the socket 2 is fixed and the pipe end fitting 3 is moved relative to it.

The pipe end fitting 3 may move longitudinally back and forth inside the socket 2, it may rotate within the socket 2 and it may also pivot within the socket 2. During the movement, the seal 6 prevents any fuel escaping from the connector 1. The conductive lip 4 is so formed that it would naturally have a smaller inner circumference than the pipe end fitting 3. The pipe end fitting 3 stretches the conductive lip 4 such that the resilient characteristic of the lip 4 means that it pushes onto the pipe end fitting with some pressure. Therefore, during movement, the conductive lip remains in contact with the pipe end fitting 3 as it stretches or flexes accordingly. The embedded metallic wire 4′ thus remains in contact with the pipe end fitting 3 and electrical contact across the connector is maintained. Alternatively the conductive lip could be made up of at least one flange, the flange partially extending around the pipe end fitting 3 and the socket 2. In a further alternative, the lip could be replaced by at least one, though preferably a plurality of, metallic brushes in a similar configuration.

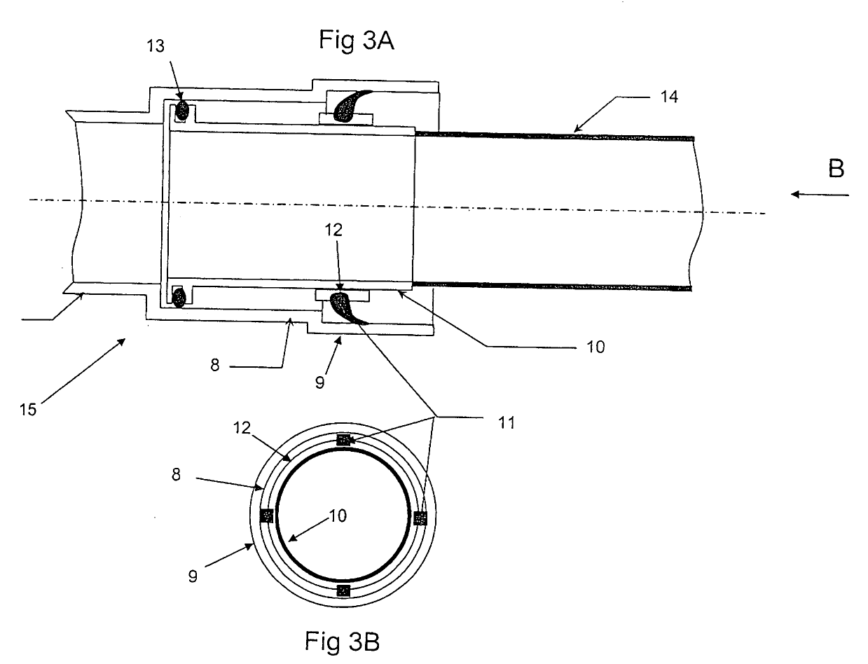

FIG. 3A shows a second embodiment of the invention including a fuel pipe coupling 15 comprising a socket 8, the socket including an extended section 9 with a wider radius than that of the main part of the socket, a pipe end fitting 10, a plurality of metallic brushes 11, a flange 12, an O-ring seal 13, and a pipe 14. The pipe end fitting 10 is located within the socket 8 and includes the seal 13 between the male outer surface of the pipe end fitting 10 and the female inner surface of the socket 8. The flange 12 is welded to the pipe end fitting 10. The plurality of metallic brushes 11 are attached to the flange 12, both the flange 12 and the brushes 11 situated such that they are within the extended section 9 of the socket 8. The brushes 11 extend from the flange 12 such that they contact the extended section 9 of the socket 8.

FIG. 3B is a view of the connector 15 from the direction of arrow B in FIG. 3A. It shows the pipe end fitting 10, the flange 12, the metallic brushes 11 and the socket 8, including the extended part 9. The metallic brushes 11 extend from the flange 12 on the pipe end fitting and provide an electrical contact to the socket 8.

The pipe coupling 15 is, in contrast to the first embodiment, a semi-flexible pipe coupling. The socket of the coupling is fixed relative to the adjacent aircraft structure, whereas the pipe end fitting and the pipe attached thereto are free to move in the same way as described above with reference to FIGS. 2A and 2B. The metallic brushes 11 would naturally extend from the flange 12 a distance greater than that required to contact the extended section 9 of the socket 8. The brushes 11 are bent and under compression in the coupling 15. They exert pressure on the extended section 9 and are such that they extend or flex with the movement of the pipe end fitting, thereby always maintaining electrical contact between the socket 8 and the pipe end fitting 10.

Whilst the present invention has been described and illustrated with reference to particular embodiments, it will be appreciated by those of ordinary skill in the art that the invention lends itself to many different variations not specifically illustrated herein.

For example, in either embodiment, elastomeric material could be used, the material being carbon loaded such that it becomes sufficiently conductive to prevent sudden electrical discharges between the pipes connected by the coupler. Either the nut of the first embodiment or the flange of the second embodiment could be screwed or clipped onto the socket or pipe end fitting respectively. This would result in easy replacement should the conductive element be worn down or damaged needing replacement. The nut or flange including the electrical contact elements could be produced as retrofit kits for existing fuel pipe connectors.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims.

1. A coupling for connecting fuel pipes wherein at least one of the fuel pipes is capable of movement with respect to the coupling, the coupling comprising
a pipe end fitting and a socket arrangement, the pipe end fitting being located within the socket arrangement, and
at least one resiliently flexible electrical contact located between the pipe end fitting and the socket arrangement.

2. A coupling according to claim 1, wherein the resiliently flexible contact is attached to either one of the pipe end fitting or the socket arrangement.

3. A coupling according to claim 1, wherein the resiliently flexible contact is slideably movable with respect to either one of the pipe end fitting or the socket arrangement.

4. A coupling according to claim 1, wherein the resiliently flexible electrical contact comprises an electrically conductive brush.

5. A coupling according to claim 1, wherein the at least one resiliently flexible electrical contact comprises a plurality of electrically conductive brushes located between the pipe end fitting and the socket arrangement.

6. A coupling according to claim 4, wherein the or each electrically conductive brush is metallic.

7. A coupling according to claim 1, wherein the resiliently flexible electrical contact comprises an electrically conductive lip.

8. A coupling according to claim 1, wherein the resiliently flexible electrical contact comprises a carbon-loaded elastomeric material.

9. A coupling according to claim 1, wherein the resiliently flexible electrical contact includes embedded metallic wires.

10. A coupling according to claim 1, wherein the resiliently flexible electrical contact is removable from the coupling.

11. A method of connecting a first aircraft fuel pipe to a second aircraft fuel pipe, wherein the method comprises the steps of:
forming a first pipe end at an end of the first pipe,
attaching a socket to an end of the second pipe, the first pipe end being at least partially accommodated by the socket in sealing engagement, thereby physically joining the first and second pipes in fluid communication,
electrically connecting the first pipe to the second pipe by means of providing a resiliently flexible electrical contact between the first pipe end and the socket, and
causing at least one of the first pipe and the second pipe to move relative to the other of the first pipe and the second pipe.

12. A kit of parts for electrically connecting fuel pipes, wherein the kit of parts includes
a pipe end fitting and a socket arrangement for forming a fuel pipe coupling and
a resiliently flexible electrical contact suitable for arrangement between, and for electrically connecting, the pipe end fitting and the socket arrangement.

13. An aircraft including a fuel system comprising a plurality of fuel pipes and at least one coupling as claimed in claim 1.

14. An aircraft fuel system including a plurality of fuel pipes and at least one coupling as claimed in claim 1.
